(19) United States
(12) Patent Application Publication
(10) Pub. No.: US 2026/0323766 A1
(43) Pub. Date: Oct. 15, 2026

(54) METHOD AND APPARATUS FOR TRANSMITTING DOWNLINK CONTROL INFORMATION, AND STORAGE MEDIUM

(71) Applicant: Beijing Xiaomi Mobile Software Co., Ltd., Beijing (CN)

(72) Inventor: Ting FU, Beijing (CN)

(21) Appl. No.: 19/485,567

(22) PCT Filed: May 19, 2023
(86) PCT No.: PCT/CN2023/095392

§ 371 Date: Nov. 18, 2025

(51) Int. Cl. H04W 76/28

(52) U.S. Cl. CPC H04W 76/28

(57) ABSTRACT

A method for monitoring downlink control information (DCI), includes: monitoring DCI sent by a network device within a time-domain interval where a first monitoring occasion (MO) overlaps with a first time period, where the first MO is an MO corresponding to first-format DCI that a user equipment is configured to monitor, the user equipment is configured with discontinuous reception (C-DRX) on a first carrier, and the first time period is a non-active time of cell discontinuous transmission (DTX) configured by the network device on the first carrier.

### CROSS-REFERENCE TO RELATED APPLICATIONS

The present application is a U.S. National Stage of International Application No. PCT/CN2023/095392, filed on May 19, 2023, the contents of all of which are incorporated herein by reference in their entireties for all purposes.

### BACKGROUND OF THE INVENTION

Network energy saving is one of the topics in Release 18 (R18) of the 3rd generation partnership project (3GPP). A network energy-saving project aims to study technologies to reduce energy consumption of a network device, and one possible method to achieve network energy saving is discontinuous transmission (DTX) of cell base stations. In addition, one energy-saving method for user equipment (UE) is connected discontinuous reception (C-DRX) defined by Release 15 (R15).

### SUMMARY OF THE INVENTION

In a first aspect, the present disclosure provides a method for monitoring downlink control information (DCI). The method is performed by user equipment and includes:
monitoring DCI sent by a network device within a time-domain interval where a first monitoring occasion (MO) overlaps with a first time period;
where the first MO is an MO corresponding to first-format DCI that the user equipment is configured to monitor, the user equipment is configured with C-DRX on a first carrier, and the first time period is a non-active time of cell DTX configured by the network device on the first carrier.

In a second aspect, the present disclosure provides a method for sending downlink control information. The method is performed by a network device and includes:
sending first-format DCI to user equipment during a second time period;
where the second time period includes a first MO, or a time-domain interval where the first MO overlaps with a first time period; and
the first MO is an MO corresponding to the first-format DCI that the user equipment is configured to monitor, the user equipment is configured with C-DRX on a first carrier, and the first time period is a non-active time of cell DTX configured by the network device on the first carrier.

In a third aspect, the present disclosure provides a communication device, including:
one or more processors;
where the one or more processors are configured to call instructions to enable the communication device to perform the method described in the first aspect, or to perform the method described in the second aspect.

In a fourth aspect, the present disclosure provides a non-transitory storage medium, storing instructions, where the instructions, when run on a communication device, enable the communication device to perform the method described in the first aspect.

### BRIEF DESCRIPTION OF DRAWINGS

Accompanying drawings illustrated here are used for providing a further understanding of the embodiments of the present disclosure, and constitute a part of the present application. The schematic embodiments and their explanations of the embodiments of the present disclosure are used for explaining the embodiments of the present disclosure and do not constitute an improper limitation on the embodiments of the present disclosure.

The accompanying drawings here, which are incorporated in and constitute a part of this specification, illustrate embodiments consistent with the embodiments of the present disclosure and serve, together with the specification, to explain the principles of the embodiments of the present disclosure.

FIG. 1 is a schematic architectural diagram of a wireless communication system provided by an embodiment of the present disclosure.

FIG. 2a is a schematic diagram of interaction of a method for transmitting downlink control information provided by an embodiment of the present disclosure.

FIG. 2b is a schematic diagram of C-DRX provided by an embodiment of the present disclosure.

FIG. 3a is a flowchart of a method for monitoring downlink control information provided by an embodiment of the present disclosure.

FIG. 3b is a flowchart of a method for monitoring downlink control information provided by an embodiment of the present disclosure.

FIG. 4a is a flowchart of a method for sending downlink control information provided by an embodiment of the present disclosure.

FIG. 4b is a flowchart of a method for sending downlink control information provided by an embodiment of the present disclosure.

FIG. 5a is a schematic diagram of a communication device shown according to an embodiment of the present disclosure.

FIG. 5b is a schematic diagram of a communication device shown according to an embodiment of the present disclosure.

FIG. 6a is a schematic diagram of a communication device shown according to an embodiment of the present disclosure.

FIG. 6b is a schematic diagram of a communication device shown according to an embodiment of the present disclosure.

### DETAILED DESCRIPTION OF THE INVENTION

Embodiments of the present disclosure provide a method and device for transmitting downlink control information, and a storage medium.

The embodiments of the present disclosure are not exhaustive and are merely an illustration of some embodiments, and do not serve as a specific limitation on the scope of protection of the present disclosure. In a case of no contradiction, each step in a certain embodiment may be implemented as an independent embodiment, and the steps may be combined arbitrarily. For example, the solution after removing some steps in a certain embodiment may also be implemented as an independent embodiment, and the order of each step in a certain embodiment may be exchanged arbitrarily. In addition, the optional implementations in a certain embodiment may be combined arbitrarily. Moreover, various embodiments may be combined arbitrarily. For example, some or all steps of different embodiments may be combined arbitrarily, and a certain embodiment may be combined arbitrarily with optional implementations of other embodiments.

In each embodiment of the present disclosure, in a case where there are no special illustrations or logical conflicts, the terminology and/or descriptions between the embodiments are consistent and may be referenced to each other. The technical features in different embodiments may be combined to form new embodiments according to their inherent logical relationships.

The terms used in the embodiments of the present disclosure are merely for the purpose of describing specific embodiments and are not intended to limit the present disclosure.

In the embodiments of the present disclosure, unless otherwise specified, elements represented in a singular form, such as “a,” “one,” “this,” “the above,” “said,” “aforementioned,” “the one,” etc., may represent “one and only one,” “one or more,” “at least one,” etc. For example, in translation, in a case of using articles such as “a,” “an,” “the” in English, the noun after the article may be understood as a singular or plural expression.

In the embodiment of the present disclosure, “a plurality of” refers to two or more than two.

In some embodiments, the terms such as “at least one of,” “one or more,” “a plurality of,” and “multiple,” may be replaced with each other.

The description methods such as “at least one of A, B, or C . . . ” and “A and/or B and/or C . . . ” in the embodiments of the present disclosure include a case where any one of A, B, C . . . exists alone, as well as a case of any combination of any multiple of A, B, C . . . , and each case may exist alone. For example, “at least one of A, B, or C” includes cases where A is alone, B is alone, C is alone, A and B are combined, A and C are combined, B and C are combined, and A and B and C are combined. For example, A and/or B include cases where A is alone, B is alone, and A and B are combined.

In some embodiments, the records such as “in one case A, in another case B,” “in response to a case A, in response to another case B” may include the following technical solutions depending on the situations: A is performed independently of B, that is, in some embodiments, A; B is performed independently of A, that is, in some embodiments, B; A and B are selectively performed, that is, in some embodiments, A or B is selected to be performed; and A and B are both performed, that is, in some embodiments, A and B. In a case where there are more branches such as A, B, and C, it is similar to the above.

The prefix words such as “first” and “second” in the embodiments of the present disclosure are merely used to distinguish different described objects and do not limit the position, the order, the priority, the number, or the content of the described objects. The statement of the described objects may refer to descriptions in the claims or the context of the embodiments, and should not constitute superfluous limitations due to the use of prefix words. For example, in a case where the described object is a “field”, the ordinal numbers before the “field” in the “first field” and the “second field” do not limit the position or order between the “fields”. The “first” and the “second” do not limit whether the “fields” they modify are in the same message, nor do they limit the order of the “first field” and the “second field”. For another example, in a case where the described object is a “level”, then the ordinal numbers before the “level” in the “first level” and the “second level” do not limit the priority between the “levels”. For example, the number of the described objects is not limited by ordinal numbers and may be one or more. Taking “first apparatus” as an example, the number of the “apparatuses” may be one or more. In addition, objects modified by different prefix words may be the same or different. For example, in a case where the described object is an “apparatus”, then the “first apparatus” and the “second apparatus” may be the same apparatus or different apparatuses, and their types may be the same or different. For example, in a case where the described object is “information”, then the “first information” and the “second information” may be the same information or different information, and their contents may be the same or different.

In some embodiments, “including A,” “containing A,” “used to indicate A” and “carrying A” may be interpreted as directly carrying A or indirectly indicating A.

In some embodiments, the terms such as “in response to . . . ,” “in response to determining . . . ,” “in a case of . . . ,” “at the time of . . . ,” “when . . . ,” “if . . . ” and “on condition that . . . ” may be interchangeable.

In some embodiments, the terms such as “greater than,” “greater than or equal to,” “not less than,” “more than,” “more than or equal to,” “no less than,” “higher than,” “higher than or equal to,” “not lower than,” and “above” may be replaced with each other, and the terms such as “less than,” “less than or equal to,” “not greater than,” “fewer than,” “fewer than or equal to,” “not more than,” “lower than,” “lower than or equal to,” “not higher than,” and “below” may be replaced with each other.

In some embodiments, the apparatus and the like may be interpreted as physical or virtual, and their names are not limited to the names recorded in the embodiments. The terms such as “apparatus,” “equipment,” “device,” “circuit,” “network element,” “node,” “function,” “unit,” “section,” “system,” “network,” “chip,” “system on chip,” “entity,” and “subject,” may be replaced with each other.

In some embodiments, the terms such as “access network device (AN device),” “radio access network device (RAN device),” “base station (BS),” “radio base station,” “fixed station,” “node,” “access point,” “transmission point (TP),” “reception point (RP),” and “transmission/reception point (TRP)” may be replaced with each other.

In some embodiments, the terms such as “terminal,” “terminal device,” “user equipment (UE),” “user terminal,” “mobile station (MS),” “mobile terminal (MT),” subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client and client may be replaced with each other.

In some embodiments, the access network device, the core network device, or the network device may be replaced with the terminal. For example, the various embodiments of the present disclosure may also be applied to a structure that replaces communication between the access network device, the core network device, or the network device and the terminal with communication between multiple terminals (such as being referred to as device-to-device (D2D), and vehicle-to-everything (V2X)). In this case, it may also be a structure that the terminal has all or part of the functions of the access network device. In addition, languages such as “uplink” and “downlink” may also be replaced with languages corresponding to communication between the terminals (such as “side”). For example, an uplink channel and a downlink channel may be replaced with sidelink channels, and an uplink and a downlink may be replaced with sidelinks.

In some embodiments, the terminal may be replaced with the access network device, the core network device, or the network device. In this case, it may also be a structure that the access network device, the core network device, or the network device has all or part of the functions of the terminal.

In some embodiments, “acquire,” “obtain,” “get,” “receive,” “transmit” and “send and/or receive” may be replaced with each other, which can be interpreted as receiving from other entities, acquiring from protocols, obtaining by self-processing, autonomous implementation, and other meanings.

In some embodiments, the terms such as “send,” “emit,” “report,” “issue,” “transmit,” and “send and/or receive” may be replaced with each other.

In some embodiments, “predetermined” and “preset” may be interpreted as being predetermined in a protocol or the like, or as performing pre-set actions by a device or the like.

In some embodiments, determining may be interpreted as judgment, deciding, judging, calculating, computing, processing, deriving, investigating, looking up, search, inquiry, ascertaining, receiving, transmitting, input, output, accessing, resolving, selecting, choosing, establishing, comparing, assuming, expecting, considering, broadcasting, notifying, communicating, forwarding, configuring, reconfiguring, allocating, mapping, assigning, etc., but not limited to these.

In some embodiments, the judging or judgment may be made based on a value (0 or 1) represented by 1 bit, a true-false value (Boolean) represented by true or false, or a comparison of numerical values (such as comparison with a predetermined value), but not limited to these.

In some embodiments, “network” may be interpreted as device contained within the network (such as the access network device and the core network device).

In some embodiments, “not expecting to receive” may be interpreted as not receiving on time domain resources and/or frequency domain resources, or as not performing subsequent processing on received data or the like after receiving the data or the like. “Not expecting to send” may be interpreted as not sending, or as sending but not expecting a receiver to respond to the content being sent.

In some embodiments, obtaining data and information may comply with the laws and regulations of the country where it is located.

In some embodiments, the data, the information, etc. may be obtained with the user's consent.

In addition, each element, row, or column in the table of the embodiments of the present disclosure may be implemented as an independent embodiment, and a combination of any each element, any row, or any column may also be implemented as an independent embodiment.

FIG. 1 is a schematic architectural diagram of a communication system shown according to an embodiment of the present disclosure.

As shown in FIG. 1, the communication system 100 includes user equipment 101 and a network device 102.

In some embodiments, the user equipment 101 includes, for example, at least one of a mobile phone, a wearable device, an Internet-of-Things device, a vehicle with a communication function, a smart vehicle, a Pad, a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, or a wireless terminal device in a smart home, but not limited to these.

In some embodiments, the network device 102 may include at least one of an access network device or a core network device.

In some embodiments, the access network device is, for example, a node or device that accesses a terminal to a wireless network. The access network device may include at least one of an evolved nodeB (eNB), a next generation eNB (ng-eNB), a next generation nodeB (gNB), a node B (NB), a home node B (HNB), a home evolved nodeB (HeNB), a wireless backhaul device, a radio network controller (RNC), a base station controller (BSC), a base transceiver station (BTS), a base band unit (BBU), a mobile switching center in a 5G communication system, a base station, an open radio access network (Open RAN), a cloud radio access network (Cloud RAN) in 6G communication system, base stations in other communication systems, or an access node in a wireless fidelity (WiFi) system, but not limited to these.

In some embodiments, the technical solution of the present disclosure may be applicable to an Open RAN architecture. In this case, interfaces between or within the access network devices involved in the embodiments of the present disclosure may become internal interfaces of the Open RAN, and the flow and information exchange between these internal interfaces may be implemented by software or programs.

In some embodiments, the access network device may include a central unit (CU) and a distributed unit (DU), where the CU may also be referred to as a control unit. A CU-DU structure may separate protocol layers of the access network device, with functions of some protocol layer placed in the CU for centralized control, and functions of the remaining or all protocol layer distributed in the DU, and the DU is centrally controlled by the CU, but not limited to these.

In some embodiments, the core network device may be one device, including one or more network elements, or may also be a plurality of devices or a device cluster, each including all or part of one or more network elements. The network elements may be virtual or physical. The core network includes, for example, at least one of an evolved packet core (EPC), a 5G core network (5GCN), or a next generation core (NGC).

It may be understood that the communication system described by the embodiments of the present disclosure is for the purpose of illustrating the technical solutions of the embodiments of the present disclosure more clearly, and does not constitute a limitation to the technical solutions provided by the embodiments of the present disclosure. Those ordinarily skilled in the art may know that with evolution of the system architecture and occurrence of a new service scenario, the technical solutions provided by the embodiments of the present disclosure are also applicable to the similar technical problem.

The following embodiments of the present disclosure may be applied to the communication system 100 or part of the entity shown in FIG. 1, but are not limited to this.

The entities shown in FIG. 1 are illustrative, and the communication system may include all or part of the entities in FIG. 1, as well as other entities outside of FIG. 1. The number and form of the entities are arbitrary, and a connection relationship between the entities is illustrative. The entities can be connected in any way, whether directly or indirectly, wired or wireless.

The embodiments of the present disclosure may be applied to long term evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), future radio access (FRA), a new-radio access technology (RAT), new radio (NR), new radio access (NX), future generation radio access (NX), global system for mobile communications (GSM (registered trademark)) CDMA2000, ultra-mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), public land mobile network (PLMN), a device-to-device (D2D) system, a machine to machine (M2M) system, an Internet of Things (IoT) system, vehicle-to-everything (V2X), systems utilizing other communication methods, and next-generation systems extended based on them. In addition, the plurality of systems may be combined (such as a combination of LTE or LTE-A and 5G) to be applied.

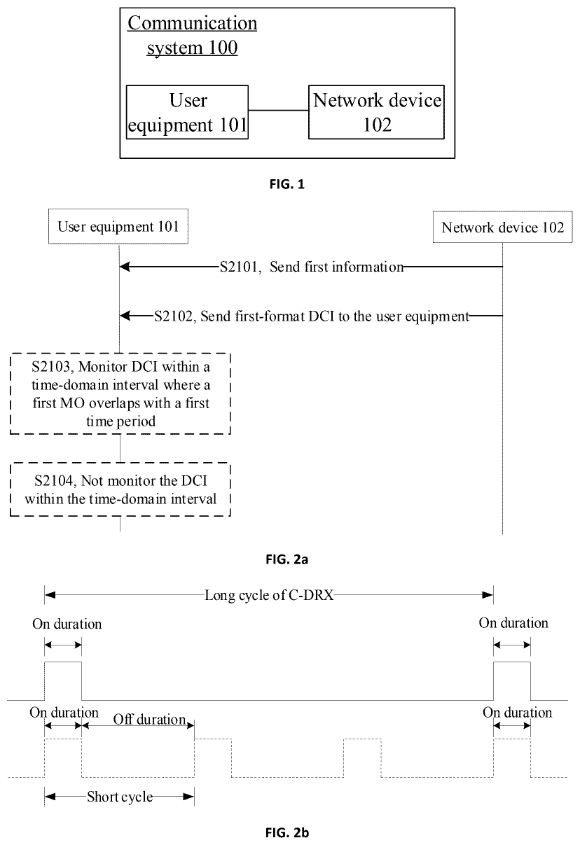

FIG. 2a is a schematic diagram of interaction of a method for transmitting downlink control information shown according to an embodiment of the present disclosure. As shown in FIG. 2a, the embodiment of the present disclosure relates to the method for transmitting the downlink control information (DCI). The method is applied to the communication system 100, and the above method includes the following step S2101 to step S2104.

In step S2101, the network device 102 sends first information to the user equipment 101.

In some embodiments, the first information is configured to indicate whether the user equipment 101 needs to monitor the DCI within a time-domain interval.

In some embodiments, the network device 102 sends higher layer signaling, and includes, indicates, or determines the first information by the higher layer signaling.

In an example, the higher layer signaling includes the first information, and the first information occupies 1 bit. In a case where a value of the 1 bit is 1, it indicates that the user equipment 101 needs to monitor the DCI within the time-domain interval. In a case where the value of the 1 bit is 0, it indicates that the user equipment 101 does not need to monitor the DCI within the time-domain interval.

In another example, a setting parameter in the higher layer signaling corresponds to the first information. In a case where the setting parameter is configured, it indicates that the user equipment 101 needs to monitor the DCI within the time-domain interval. In a case where the setting parameter is not configured, it indicates that the user equipment 101 does not need to monitor the DCI within the time-domain interval.

Alternatively, in this example, in a case where the setting parameter is configured to be a first option, it indicates that the user equipment 101 needs to monitor the DCI within the time-domain interval. In a case where the setting parameter is configured to be a second option, it indicates that the user equipment 101 does not need to monitor the DCI within the time-domain interval. The first option may be enabling, and the second option may be disabling.

In some embodiments, the time-domain interval is a time-domain interval where a first time period overlaps with a first monitoring occasion (MO). The descriptions of the first time period and the first MO may refer to the descriptions in the following embodiments.

In some embodiments, the user equipment 101 receives the first information sent by the network device 102.

In step S2102, the network device 102 sends first-format DCI to the user equipment 101 during a second time period.

In some embodiments, the second time period includes the first MO, or the time-domain interval where the first MO overlaps with the first time period.

In some embodiments, the network device 102 may send the first-format DCI to the user equipment on a first carrier, where the first carrier is a primary carrier.

In some embodiments, the network device 102 may send the first-format DCI to the user equipment on a second carrier; where the second carrier is configured with a search space for sending the first-format DCI.

In some embodiments, the second carrier is a secondary carrier in a cell group where the first carrier is located, and the user equipment is configured with a plurality of serving carriers based on carrier aggregation (CA). The cell group may include a plurality of cells, and the plurality of cells may be a plurality of cells used for carrier aggregation or dual connectivity (DC). The cell group may be, for example, a master cell group (MCG) or a secondary cell group (SCG). For example, the master cell group refers to a plurality of serving cells under a master node, and the secondary cell group refers to a plurality of serving cells under a secondary node.

In step S2103, the user equipment 101 monitors the DCI sent by the network device 102 within the time-domain interval where the first MO overlaps with the first time period.

In some embodiments, the network device 102 is configured with cell DTX on the first carrier.

In some examples, the first time period is a non-active time of the cell DTX configured by the network device 102 on the first carrier.

For example, the cell DTX of the network device 102 on the first carrier may include an on duration and an off duration. The on duration may also be referred to as DTX-on duration, and the off duration may also be referred to as DTX-off duration. The first time period may be the DTX-off duration.

During the DTX-on duration, the network device 102 is in an active time of the DTX and needs to send a downlink channel normally, such as sending a physical downlink control channel (PDCCH). During the DTX-off duration, the network device 102 is in the non-active time of the DTX and may not send certain downlink channels or downlink signals, such as not sending a specific PDCCH.

In some embodiments, the user equipment 101 is configured with C-DRX on the first carrier.

In one example, during the C-DRX, a time period during which the user equipment 101 does not monitor some downlink information such as the PDCCH is the non-active time of the C-DRX, and a time period during which the user equipment 101 normally monitors the downlink information such as the PDCCH is the active time of the C-DRX.

Taking a cycle C-DRX shown in FIG. 2b as an example, one C-DRX cycle includes a C-DRX off duration and a C-DRX on duration. As shown in FIG. 2b, in the C-DRX configured with a long cycle, the cycle of the C-DRX is relatively long. In a case of nesting a short cycle within the long cycle, the C-DRX further includes a plurality of short cycles that occur within the long cycle. The user equipment 101 monitors the downlink information according to the configured C-DRX on duration. In a case where the user equipment 101 is configured with the C-DRX with the long cycle and the short cycle simultaneously, after the C-DRX with the short cycle is started, the user equipment 101 monitors the downlink information according to the C-DRX with the long cycle after a drx-ShortCycleTimer expires.

In this example, the network device 102 may configure time-domain parameters of the C-DRX, such as at least one of a C-DRX cycle, a duration of the C-DRX off duration, a duration of the C-DRX on duration, or other parameters.

In this example, a timer corresponding to the C-DRX on duration is drx-onDuration Timer, and the timer is configured to indicate the duration of the C-DRX on duration. The timer starts at the start moment of entering the C-DRX on duration each time.

In some examples, the first MO is an MO corresponding to the first-format DCI that the user equipment 101 is configured to monitor.

In some examples, the first-format DCI is, for example, DCI 2-6.

In some examples, the DCI 2-6 is transmitted in the PDCCH and is sent before the start of the C-DRX on duration in each C-DRX cycle, and is configured to indicate whether the user equipment 101 normally starts the C-DRX on duration after the DCI 2-6.

In some examples, in the enhancement of the C-DRX, the DCI 2-6 is configured to send a wake-up indication. In a case where the wake-up indication carried in the DCI 2-6 correspondingly indicates that the user equipment 101 is woken up, the user equipment 101 starts one C-DRX on duration after the wake-up indication. In a case where the wake-up indication correspondingly indicates that the user equipment 101 is not woken up, the user equipment 101 does not start the C-DRX on duration after the wake-up indication.

In some embodiments, within the time-domain interval, the user equipment 101 may monitor the first-format DCI, such as the DCI 2-6.

In some embodiments, the first MO is before the C-DRX on duration; where an interval between a start time for monitoring the DCI by the user equipment 101 and a start time of the C-DRX on duration is a first duration.

In some examples, the first duration is configured by the network device 102.

For example, the first duration is configured by the network device via the higher layer signaling.

In some embodiments, step S2103 may use step S2103-1, specifically:

in step S2103-1, the user equipment 101 monitors the first-format DCI sent by the network device 102 on the first carrier within the time-domain interval where the first MO overlaps with the first time period.

In some examples, the first carrier is the primary carrier.

In some examples, in the carrier aggregation (CA) scenario, the user equipment 101 may be configured with a plurality of serving cells, and the network device 102 may merely send the DCI 2-6 on a primary serving cell or the primary carrier. Thus, the user equipment 101 may merely monitor the DCI 2-6 within the time-domain interval on the primary carrier.

In some embodiments, step S2102 may use step S2103-2, specifically:

in step S2103-2, the user equipment 101 monitors the first-format DCI sent by the network device 102 on the second carrier within the time-domain interval where the first MO overlaps with the first time period;

where the second carrier is configured with the search space for sending the first-format DCI.

In some examples, the second carrier may be different from the first carrier.

In some examples, the second carrier is the secondary carrier in the cell group where the first carrier is located, and the user equipment 101 is configured with the plurality of serving carriers based on the CA.

In some embodiments, in a case where the method includes step S2101, and the network device 102 indicates by the first information that the user equipment 101 monitors the DCI within the time-domain interval, the user equipment 101 performs steps S2102, S2102-1, or S2102-2.

In step S2104, the user equipment 101 does not monitor the DCI within the time-domain interval.

In some embodiments, in a case where the method includes step S2101, and the first information indicates that the user equipment 101 does not need to monitor the DCI within the time-domain interval, the user equipment 101 performs step S2103 without performing steps S2102, S2102-1, or S2102-2.

In some embodiments, steps S2101 and S2104 are optional.

In some embodiments, steps S2103 and S2104 are parallelly implemented steps, and one of the steps may be performed according to the first information.

In some embodiments, the order of steps S2102 and S2103 is merely illustrative.

In some embodiments, in a case where the method includes step S2104, the method may not include steps S2102 and S2103, that is, the method includes steps S2101 and S2104.

In some embodiments, the method includes steps S2102 and S2103.

In some embodiments, the method includes steps S2101, S2102 and S2103.

In the embodiment of the present disclosure, the user equipment 101 may normally monitor the DCI within the time-domain interval where the first MO overlaps with the first time period, thus in a scenario where the network device 102 applies the cell DTX, the user equipment 101 is configured with the C-DRX, and the user equipment 101 is configured to monitor the first-format DCI, the user equipment 101 can also maintain necessary downlink information monitoring, so that the user equipment can be woken up promptly in an energy-saving state.

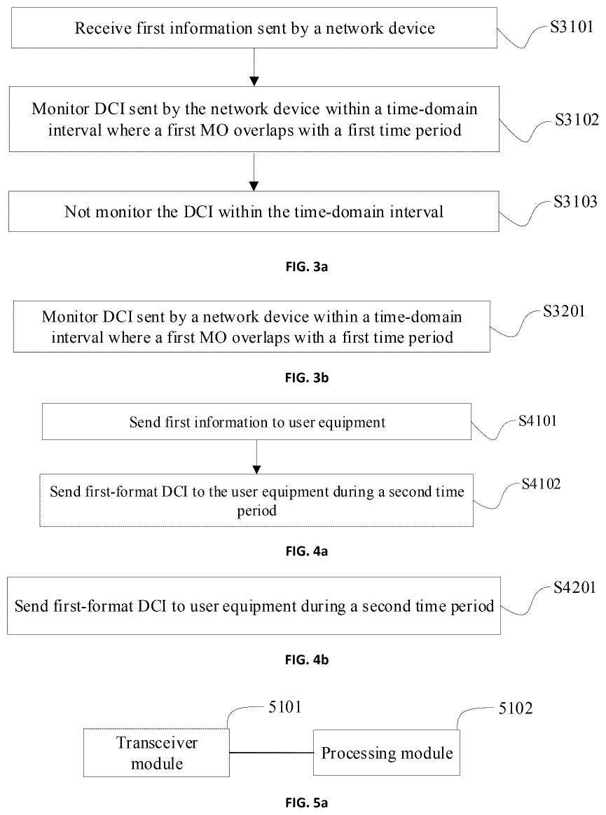

FIG. 3a is a schematic flowchart of a method for monitoring downlink control information shown according to an embodiment of the present disclosure. As shown in FIG. 3a, the embodiment of the present disclosure relates to the method for monitoring the downlink control information. The method is performed by the user equipment 101, and the above method includes the following step S3101 to step S3103.

In step S3101, the user equipment 101 receives first information sent by the network device 102.

In some embodiments, the implementation of step S3101 may refer to the relevant implementation of step S2101, which is omitted here.

In some embodiments, the first information is configured to indicate whether the user equipment needs to monitor the DCI within a time-domain interval.

In some embodiments, the network device 102 indicates by the first information that the user equipment 101 monitors the DCI within the time-domain interval. In an example, in a case where the first information indicates that the user equipment 101 needs to monitor the DCI within the time-domain interval, the user equipment 101 monitors and receives the DCI within the time-domain interval, such as performing step S3102 below.

In step S3102, the user equipment 101 monitors the DCI sent by the network device 102 within the time-domain interval where a first MO overlaps with a first time period.

In some embodiments, the implementation of step S3102 may refer to the relevant implementation of step S2103, which is omitted here.

In some embodiments, the first MO is an MO corresponding to first-format DCI that the user equipment is configured to monitor, the user equipment is configured with connected discontinuous reception (C-DRX) on a first carrier, and the first time period is a non-active time of cell discontinuous transmission (DTX) configured by the network device on the first carrier.

In some embodiments, in a case where the first information indicates that the user equipment monitors the DCI within the time-domain interval, the user equipment 101 monitors and receives DCI 2-6 within the time-domain interval, such as performing step S3102.

In some embodiments, the first MO is before C-DRX on duration; where an interval between a start time for monitoring the DCI by the user equipment 101 and a start time of the C-DRX on duration is a first duration.

In some examples, the first duration is configured by the network device 102.

For example, the first duration is configured by the network device via higher layer signaling.

In some embodiments, step S3102 may adopt step S3102-1, specifically:

in step S3102-1, the user equipment 101 monitors the first-format DCI sent by the network device 102 on the first carrier within the time-domain interval where the first MO overlaps with the first time period.

In some examples, the first carrier is a primary carrier.

In some examples, the implementation of step S3102-1 may refer to the relevant implementation of step S2103-1.

In some embodiments, step S3102 may adopt step S3102-2, specifically:
in step S3102-2, the user equipment 101 monitors the first-format DCI sent by the network device 102 on a second carrier within the time-domain interval where the first MO overlaps with the first time period;
where the second carrier is configured with a search space for sending the first-format DCI.

In some examples, the second carrier is a secondary carrier in a cell group where the first carrier is located, and the user equipment 101 is configured with a plurality of serving carriers based on CA.

In some examples, the implementation of step S3102-2 may refer to the relevant implementation of step S2103-2.

In step S3103, the user equipment 101 does not monitor the DCI within the time-domain interval.

In some embodiments, the implementation of step S3103 may refer to the relevant implementation of step S2104, which is omitted here.

The first information indicates that the user equipment does not need to monitor the DCI within the time-domain interval.

In some embodiments, steps S3101 and S3103 are optional.

In some embodiments, the method includes steps S3102, S3102-1 or S3102-2.

In some embodiments, the method includes steps S3101 and S3102.

In some embodiments, the method includes steps S3101 and S3103.

In the embodiment of the present disclosure, the user equipment 101 may normally monitor the DCI within the time-domain interval where the first MO overlaps with the first time period, thus in a scenario where the network device 102 applies the cell DTX, the user equipment 101 is configured with the C-DRX; and the user equipment 101 is configured to monitor the first-format DCI, the user equipment 101 can also maintain necessary downlink information monitoring, so that the user equipment can be woken up promptly in an energy-saving state.

FIG. 3b is a schematic flowchart of a method for monitoring downlink control information shown according to an embodiment of the present disclosure. As shown in FIG. 3b, the embodiment of the present disclosure relates to the method for monitoring the downlink control information. The method is performed by the user equipment 101, and the above method includes the following step S3201.

In step S3201, the user equipment 101 monitors the DCI sent by the network device 102 within the time-domain interval where the first MO overlaps with the first time period.

In some embodiments, the implementation of step S3201 may refer to the relevant implementation of steps S2103 and S3102, which is omitted here.

In some embodiments, the first MO is an MO corresponding to the first-format DCI that the user equipment is configured to monitor, the user equipment is configured with the C-DRX on the first carrier, and the first time period is the non-active time of cell DTX configured by the network device on the first carrier.

In some embodiments, step S3201 may use step S3201-1, specifically:

in step S3201-1, the user equipment 101 monitors the first-format DCI sent by the network device 102 on the first carrier within the time-domain interval where the first MO overlaps with the first time period.

In some examples, the first carrier is the primary carrier.

In some examples, the implementation of step S3201-1 may refer to the relevant implementation of step S2103-1.

In some embodiments, step S3201 may use step S3201-2, specifically:

in step S3201-2, the first-format DCI sent by the network device is monitored on the second carrier within the time-domain interval where the first MO overlaps with the first time period.

In some examples, the implementation of step S3201-2 may refer to the relevant implementation of step S2103-2.

In some examples, the second carrier is configured with the search space for sending the first-format DCI.

In some examples, the second carrier is the secondary carrier in the cell group where the first carrier is located, and the user equipment is configured with the plurality of serving carriers based on the CA.

In some embodiments, the first MO is before the C-DRX on duration;

where the interval between the start time for monitoring the DCI by the user equipment and the start time of the C-DRX on duration is the first duration.

In some examples, the first duration is configured by the network device.

In some embodiments, the network device indicates by the first information that the user equipment monitors the DCI within the time-domain interval.

In some embodiments, the following step S3200 is further included before step S3201, specifically:

in step S3200, the user equipment 101 receives the first information sent by the network device 102, where the first information is configured to indicate whether the user equipment needs to monitor the DCI within the time-domain interval.

In some examples, the implementation of step S3200 may refer to the relevant implementation of step S2101, which is omitted here.

In some examples, in a case where the first information indicates that the user equipment monitors the DCI within the time-domain interval, the user equipment 101 monitors and receives DCI 2-6 within the time-domain interval, such as performing step S3201.

In a case where the first information indicates that the user equipment does not need to monitor the DCI within the time-domain interval, the method uses step S3201′ to replace the above step S3201, where in step S3201′, the user equipment 101 does not monitor the DCI within the time-domain interval.

In some examples, the user equipment 101 may determine whether to monitor the DCI within the overlapping time-domain interval according to the first information sent by the network device 102, so as to communicate in time while ensuring the energy-saving state.

FIG. 4a is a schematic flowchart of a method for sending downlink control information shown according to an embodiment of the present disclosure. As shown in FIG. 4a, the embodiment of the present disclosure relates to the method for sending the downlink control information. The method is performed by the network device 102, and the above method includes the following step S4101 and step S4102.

In step S4101, the network device 102 sends first information to the user equipment 101.

In some embodiments, the implementation of step S4101 may refer to the relevant implementation of step S2101, which is omitted here.

In some embodiments, the first information is configured to indicate whether the user equipment needs to monitor the DCI within a time-domain interval.

In step S4102, the network device 102 sends first-format DCI to the user equipment 101 during a second time period.

In some embodiments, the implementation of step S4102 may refer to the relevant implementation of step S2102, which is omitted here.

In some embodiments, the second time period includes a first MO, or the time-domain interval where the first MO overlaps with a first time period.

In some embodiments, the first MO is an MO corresponding to the first-format DCI that the user equipment is configured to monitor, the user equipment is configured with C-DRX on a first carrier, and the first time period is a non-active time of cell DTX configured by the network device on the first carrier.

In some embodiments, step S4101 may use step S4102-1, specifically:

in step S4102-1, the network device 102 sends the first-format DCI to the user equipment 101 on the first carrier during a second time period.

In some examples, the implementation of step S4102-1 may refer to the relevant implementation of step S2103-1, which is omitted here.

In some examples, the first carrier is a primary carrier.

In some embodiments, step S4102 may use step S4102-2, specifically:

in step S4102-2, the network device 102 sends the first-format DCI to the user equipment 101 on a second carrier during the second time period.

In some examples, the implementation of step S4102-2 may refer to the relevant implementation of step S2103-2, which is omitted here.

In some examples, the second carrier is configured with a search space for sending the first-format DCI.

In some embodiments, the second carrier is a secondary carrier in a cell group where the first carrier is located, and the user equipment is configured with a plurality of serving carriers based on carrier aggregation (CA).

In some embodiments, the first MO is before a C-DRX on duration;
where an interval between a start time for monitoring the DCI by the user equipment and a start time of the C-DRX on duration is a first duration.

In some examples, the first duration is configured by the network device.

In some embodiments, the network device indicates by the first information that the user equipment monitors the DCI within the time-domain interval.

In some embodiments, step S4101 is optional.

In some embodiments, the method includes step S4102.

In the embodiment of the present disclosure, in a scenario where the network device 102 applies the cell DTX, the user equipment 101 is configured with the C-DRX, and the user equipment 101 is configured to monitor the first-format DCI, the user equipment 101 can also maintain necessary downlink information monitoring, so that the user equipment can be woken up promptly in an energy-saving state.

FIG. 4b is a schematic flowchart of a method for sending downlink control information shown according to an embodiment of the present disclosure. As shown in FIG. 4b, the embodiment of the present disclosure relates to the method for sending the downlink control information. The method is performed by the network device 102, and the above method includes the following step S4201.

In step S4201, the network device 102 sends the first-format DCI to the user equipment 101 during the second time period.

In some embodiments, the implementation of step S4201 may refer to the relevant implementation of steps S2102 and S4202, which is omitted here.

In some embodiments, the second time period includes the first MO, or the time-domain interval where the first MO overlaps with the first time period.

In some embodiments, the first MO is an MO corresponding to the first-format DCI that the user equipment is configured to monitor, the user equipment is configured with C-DRX on the first carrier, and the first time period is the non-active time of the cell DTX configured by the network device on the first carrier.

In some embodiments, the implementation of step S4201 may further refer to the relevant implementation of steps S4102-1 or S4102-2, which is omitted here.

In some embodiments, the first MO is before the C-DRX on duration;
where the interval between the start time for monitoring the DCI by the user equipment and the start time of the C-DRX on duration is the first duration.

In some examples, the first duration is configured by the network device.

In some embodiments, the network device indicates by the first information that the user equipment monitors the DCI within the time-domain interval.

In some embodiments, the method further includes step S4200.

In step S4200, the network device 102 sends first information to the user equipment 101.

In some examples, the implementation of step S4200 may refer to the relevant implementation of step S2101, which is omitted here.

In some embodiments, in a case where the first information indicates that the user equipment does not need to monitor the DCI within the time-domain interval, the network device 102 may not send DCI 2-6 within the time-domain interval, and the user equipment 101 may not monitor the DCI 2-6. Thus, both the network device 102 and the user equipment 101 can maintain the energy-saving state.

For the convenience of understanding the embodiments of the present disclosure, some specific examples are listed below.

### EXAMPLE 1

In a case where a base station is configured with cell DTX on a first carrier, UE is configured with C-DRX on the first carrier, the UE is configured to monitor DCI 2-6 (wake-up indication) on the first carrier, and a monitoring occasion (MO) of the DCI 2-6 overlaps with a non-active period of cell DTX on the first carrier, the UE monitors the DCI 2-6 on the MO of the DCI 2-6 within an overlapping region.

In this example, the base station may send the DCI 2-6 within the overlapping region.

For example, before the on duration of each C-DRX cycle, the UE monitors the DCI 2-6 within a configured time range, which may include a plurality of (M) DCI 2-6 MOs, and the base station may send the DCI 2-6 on any one or more MOs. In a case where the overlapping region merely includes K MOs of M MOs of the DCI 2-6 (M>K), the base station may send DCI on the K MOs or on another (M−K) MOs, this is because the UE cannot determine the MO where the base station sends the DCI 2-6, but needs to monitor the DCI on the K MOs.

### EXAMPLE 2

Based on Example 1, the UE monitors the DCI 2-6 on the first carrier, and the first carrier is a primary carrier.

### EXAMPLE 3

Based on Example 1, the UE monitors the DCI 2-6 on a second carrier in a case where the UE is configured with CA.

Correspondingly, the base station sends the DCI 2-6 on the second carrier.

The second carrier is configured with a search space for sending the DCI 2-6, and is merely enabled to send the DCI 2-6 during an overlapping period. The second carrier is a secondary carrier in the same cell group as the first carrier.

### EXAMPLE 4

In a case where the base station is configured with cell DTX on the first carrier, the UE is configured with C-DRX on the first carrier, and the UE is configured to monitor the DCI 2-6 (wake-up indication) on the first carrier, then the base station may configure, via a first higher layer parameter, whether the terminal needs to monitor the DCI 2-6 in a region where the monitoring occasion (MO) of the DCI 2-6 overlaps with the non-active period of the cell DTX on the first carrier.

In a case where the first higher layer parameter configuration indicates the need for monitoring, the terminal needs to monitor the DCI 2-6 within the overlapping region; otherwise, the terminal does not monitor the DCI 2-6.

In some embodiments, the first higher layer parameter corresponds to the first information in the aforementioned embodiments.

In the embodiments of the present disclosure, some or all of the steps and their optional implementations may be arbitrarily combined with some or all of the steps in other embodiments, or arbitrarily combined with optional implementations in other embodiments.

An embodiment of the present disclosure further provides an apparatus for implementing any of the above methods. For example, an apparatus is provided, and the above apparatus includes a unit or module for implementing the steps performed by a terminal in any of the above methods. For example, another apparatus is further provided, including a unit or module for implementing the various steps performed by a network device (such as an access network device, a core network functional node, and a core network device) in any of the above methods.

It needs to be understood that the division of each unit or module in the above apparatus is merely a logical functional division. All units or modules may be fully or partially integrated into a physical entity or physically separated in actual implementation. In addition, the units or modules in the apparatus may be implemented in the form that a processor calls software. For example, the apparatus includes a processor, the processor is connected to a memory, and the memory stores instructions. The processor calls the instructions stored in the memory to implement any of the above methods or to implement the functions of each unit or module of the apparatus, where the processor is, for example, a general-purpose processor, such as a central processing unit (CPU) or a microprocessor, and the memory is a memory internal or external to the apparatus. Alternatively, the units or modules in the apparatus may be implemented in the form of a hardware circuit, and the functions of some or all of the units or modules may be realized by the design of the hardware circuit. The hardware circuit above may be understood as one or more processors. For example, in one implementation, the above hardware circuit is an application-specific integrated circuit (ASIC). The functions of some or all of the units or modules may be realized by the design of a logical relationship of components in the circuit. For another example, in another implementation, the above hardware circuit may be implemented by a programmable logic device (PLD). Taking a field programmable gate array (FPGA) as an example, it may include a large number of logic gate circuits, and a connection relationship between the logic gate circuits is configured via configuration files to achieve the functions of some or all of the above units or modules. All units or modules of the above apparatus may be implemented entirely in the form that the processor calls the software, or entirely by the hardware circuits, or partially in the form that the processor calls the software, with the remaining part by the hardware circuits.

In the embodiment of the present disclosure, the processor is a circuit with a signal processing capability. In one implementation, the processor may be a circuit with instruction reading and operating capabilities, such as a central processing unit (CPU), a microprocessor, a graphics processing unit (GPU) (which may be understood as a microprocessor), or a digital signal processor (DSP). In another implementation, the processor may achieve certain functions by the logical relationship of the hardware circuits, and the logical relationship of the hardware circuits above is fixed or reconfigurable. For example, the processor is a hardware circuit implemented by an application-specific integrated circuit (ASIC) or a programmable logic device (PLD), such as FPGA. In the reconfigurable hardware circuit, a process that the processor loads configuration documents to implement hardware circuit configuration may be understood as a process that the processor loads instructions to implement the functions of some or all of the above units or modules. In addition, it may further be a hardware circuit designed for artificial intelligence, which may be understood as an ASIC, such as a neural network processing unit (NPU), a tensor processing unit (TPU), and a deep learning processing unit (DPU).

FIG. 5a is a schematic structural diagram of a communication device provided by an embodiment of the present disclosure. The communication device may achieve the functions of the user equipment 101. As shown in FIG. 5a, the device includes: a transceiver module 5101. The transceiver module 5101 is configured to monitor downlink control information (DCI) sent by a network device within a time-domain interval where a first monitoring occasion (MO) overlaps with a first time period; where the first MO is an MO corresponding to first-format DCI that user equipment is configured to monitor, the user equipment is configured with connected discontinuous reception (C-DRX) on a first carrier, and the first time period is a non-active time of cell discontinuous transmission (DTX) configured by the network device on the first carrier.

In some examples, the above transceiver module 5101 is configured to perform the steps related to message transceiving performed by the user equipment 101 in any of the above methods, which is omitted here.

In some examples, the device further includes a processing module 5102, and the processing module 5102 is configured to perform the steps related to message processing performed by the user equipment 101 in any of the above methods, which is omitted here.

FIG. 5b is a schematic structural diagram of a communication device provided by an embodiment of the present disclosure. The communication device may achieve the functions of the network device 102. As shown in FIG. 5b, the device includes: a transceiver module 5201. The transceiver module 5201 is configured to send the first-format DCI to the user equipment during a second time period; where the second time period includes the first MO, or includes the time-domain interval where the first MO overlaps with the first time period; and the first MO is an MO corresponding to the first-format DCI that the user equipment is configured to monitor, the user equipment is configured with the connected discontinuous reception (C-DRX) on the first carrier, and the first time period is the non-active time of the cell discontinuous transmission (DTX) configured by the network device on the first carrier.

In some examples, the above transceiver module 5201 is configured to perform the steps related to transceiving performed by the network device 102 in any of the above methods, which is omitted here.

In some examples, the device further includes a processing module 5202, configured to perform the steps related to processing performed by the network device 102 in any of the above methods, such as message generation, operation processing, and other related steps, which is omitted here.

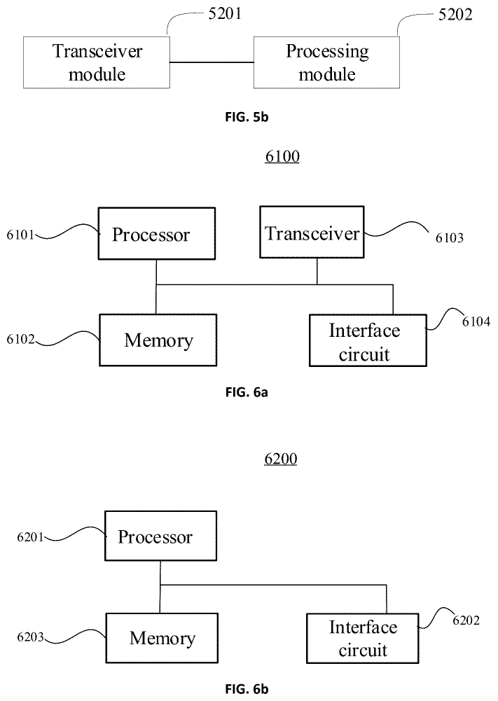

FIG. 6a is a schematic structural diagram of a communication device 6100 provided by an embodiment of the present disclosure. The communication device 6100 may be a network device (such as an access network device and a core network device), may also be a terminal (such as user equipment), may also be a chip, a system on chip, or a processor that supports the network device to implement any one of the methods above, and may further be a chip, a system on chip, or a processor that supports the terminal to implement any one of the methods above. The communication device 6100 may be configured to implement the methods described in the above method embodiments, which may specifically refer to illustration in the above method embodiments.

As shown in FIG. 6a, the communication device 6100 includes one or more processors 6101. The one or more processors 6101 may be a general-purpose processor or a special-purpose processor, such as a baseband processor or a central processing unit. The baseband processor may be configured to process a communication protocol and communication data, while the central processing unit may be configured to control the communication device (such as a base station, a baseband chip, a terminal device, a terminal device chip, and a DU or CU), execute a program, and process data from the program. The processor 6101 is configured to call the instructions to enable the communication device 6100 to perform any of the above methods.

In some embodiments, the communication device 6100 further includes one or more memories 6102 for storing instructions. In some examples, all or part of the memories 6102 may also be located outside of the communication device 6100.

In some embodiments, the communication device 6100 further includes one or more transceivers 6103. In a case where the communication device 6100 includes one or more transceivers 6103, the communication steps such as sending and receiving in the above methods are performed by the transceiver 6103, and other steps are performed by the processor 6101.

In some embodiments, the transceiver may include a receiver and a transmitter, and the receiver and the transmitter may be separate or integrated together. In some examples, the terms such as the transceiver, a transceiver unit, a transceiving machine, and a transceiver circuit may be replaced with each other. The terms such as the transmitter, a transmitter unit, a transmitting machine, and a transmitter circuit may be replaced with each other. The terms such as a receiver, a receiver unit, a receiving machine, and a receiver circuit may be replaced with each other.

In some examples, the communication device 6100 further includes one or more interface circuits 6104, and the interface circuit 6104 is connected to the memory 6102. The interface circuit 6104 may be used to receive signals from the memory 6102 or other apparatuses, and may be used to send signals to the memory 6102 or other apparatuses. For example, the interface circuit 6104 may read instructions stored in the memory 6102 and send the instructions to the processor 6101.

The communication device 6100 described in the above embodiments may be a network device or a terminal, but the scope of the communication device 6100 described in the present disclosure is not limited to this. The structure of the communication device 6100 may be not limited by FIG. 6a. The communication device may be an independent device or may be part of a larger device. For example, the communication device may be: 1) an independent integrated circuit (IC), or a chip, or a system on chip or a subsystem; (2) a set of one or more ICs, in some examples, the above IC set including storage components for storing data and programs; (3) ASIC, such as a modem; (4) modules that can be embedded in other devices; (5) a receiver, a terminal device, an intelligent terminal device, a cellular phone, a wireless device, a handset, a mobile unit, a vehicle UE, a network device, a cloud device, an artificial intelligence device, etc.; and (6) others and so on.

FIG. 6b is a schematic structural diagram of a chip 6200 provided by an embodiment of the present disclosure. For a case where the communication device 6100 may be a chip or a system on chip, please refer to a schematic structural diagram of the chip 6200 shown in FIG. 6b, but it is not limited to this. The chip 6200 includes one or more processors 6201, and the one or more processors 6201 are configured to call instructions to enable the chip 6200 to perform any of the above methods.

In some embodiments, the chip 6200 further includes one or more interface circuits 6202, and the one or more interface circuits 6202 are connected to a memory 6203. The interface circuit 6202 may be used to receive signals from the memory 6203 or other devices, and the one or more interface circuits 6202 may be used to send signals to the memory 6203 or other devices. For example, the one or more interface circuits 6202 may read instructions stored in the memory 6203 and send the instructions to the processor 6201. In some examples, the terms such as the interface circuit, an interface, a transceiver pin, and the transceiver may be replaced with each other.

In some embodiments, the chip 6200 further includes one or more memories 6203 for storing instructions. In some examples, all or part of the memories 6203 may be located outside of the chip 6200.

The present disclosure further provides a storage medium on which instructions are stored. The instructions, when run on the communication device 6100, enable the communication device 6100 to perform any of the above methods. In some examples, the above storage medium is an electronic storage medium. In some examples, the above storage medium is a computer-readable storage medium, but is not limited to this, and it may also be a storage medium readable by other apparatuses. In some examples, the above storage medium may be a non-transitory storage medium, but is not limited to this, and it may also be a transitory storage medium.

The present disclosure further provides a program product. The above program product, when executed by the communication device 6100, enables the communication device 6100 to perform any of the above methods. In some examples, the above program product is a computer program product.

The present disclosure further provides a computer program. The computer program, when run on a computer, enables the computer to perform any of the above methods.

### INDUSTRIAL APPLICABILITY

In the method of the present disclosure, the user equipment may normally monitor the DCI within the time-domain interval where the first MO overlaps with the first time period, thus in a scenario where the network device applies the cell DTX, the user equipment is configured with the C-DRX, and the user equipment is configured to monitor the first-format DCI, the user equipment can also maintain necessary downlink information monitoring, so that the user equipment can be woken up promptly in an energy-saving state.

1. A method for monitoring downlink control information (DCI), performed by user equipment, the method comprising:
monitoring DCI sent by a network device within a time-domain interval where a first monitoring occasion (MO) overlaps with a first time period;
wherein the first MO is an MO corresponding to first-format DCI that the user equipment is configured to monitor, the user equipment is configured with connected discontinuous reception (C-DRX) on a first carrier, and the first time period is a non-active time of cell discontinuous transmission (DTX) configured by the network device on the first carrier.

2. The method according to claim 1, wherein monitoring the DCI sent by the network device comprises:
monitoring the first-format DCI sent by the network device on the first carrier, wherein the first carrier is a primary carrier.

3. The method according to claim 1, wherein monitoring the DCI sent by the network device comprises:
monitoring the first-format DCI sent by the network device on a second carrier;
wherein the second carrier is configured with a search space for sending the first-format DCI.

4. The method according to claim 3, wherein
the second carrier is a secondary carrier in a cell group where the first carrier is located, and the user equipment is configured with a plurality of serving carriers based on carrier aggregation (CA).

5. The method according to claim 1, wherein
the first MO is before a C-DRX on duration;
wherein an interval between a start time for monitoring the DCI by the user equipment and a start time of the C-DRX on duration is a first duration.

6. The method according to claim 5, wherein
the first duration is configured by the network device.

7. The method according to claim 1, wherein
the user equipment is indicated by the network device via first information to monitor the DCI within the time-domain interval.

8. The method according to claim 7, further comprising:
receiving the first information sent by the network device, wherein the first information is configured to indicate whether the user equipment needs to monitor the DCI within the time-domain interval.

9. The method according to claim 8, further comprising:
not monitoring the DCI within the time-domain interval;
wherein the first information indicates that the user equipment does not need to monitor the DCI within the time-domain interval.

10. A method for sending downlink control information (DCI), performed by a network device, the method comprising:
sending first-format DCI to user equipment during a second time period;
wherein the second time period comprises a first monitoring occasion (MO), or a time-domain interval where the first MO overlaps with a first time period; and
the first MO is an MO corresponding to the first-format DCI that the user equipment is configured to monitor, the user equipment is configured with connected discontinuous reception (C-DRX) on a first carrier, and the first time period is a non-active time of cell discontinuous transmission (DTX) configured by the network device on the first carrier.

11. The method according to claim 10, wherein sending the first-format DCI to the user equipment comprises:
sending the first-format DCI to the user equipment on the first carrier, wherein the first carrier is a primary carrier.

12. The method according to claim 10, wherein sending the first-format DCI to the user equipment comprises:
sending the first-format DCI to the user equipment on a second carrier;
wherein the second carrier is configured with a search space for sending the first-format DCI.

13. The method according to claim 12, wherein
the second carrier is a secondary carrier in a cell group where the first carrier is located, and the user equipment is configured with a plurality of serving carriers based on carrier aggregation (CA).

14. The method according to claim 10, wherein
the first MO is before a C-DRX on duration;
wherein an interval between a start time for monitoring the DCI by the user equipment and a start time of the C-DRX on duration is a first duration.

15. The method according to claim 14, wherein
the first duration is configured by the network device.

16. The method according to claim 10, wherein
the network device indicates, via first information, the user equipment to monitor the DCI within the time-domain interval.

17. The method according to claim 16, further comprising:
sending the first information to the user equipment, wherein the first information is configured to indicate whether the user equipment needs to monitor the DCI within the time-domain interval.

18-20. (canceled)

21. A communication device, comprising:
one or more processors;
wherein the one or more processors are configured to execute instructions to cause the communication device to perform the method according to claim 10.

22. A non-transitory storage medium, storing instructions, wherein the instructions, when executed by a communication device, cause the communication device to perform the method according to claim 1. perform

23. A communication device, comprising:
one or more processors;
wherein the one or more processors are configured to execute instructions to:
monitor downlink control information (DCI) sent by a network device within a time-domain interval where a first monitoring occasion (MO) overlaps with a first time period;
wherein the first MO is an MO corresponding to first-format DCI that user equipment is configured to monitor, the user equipment is configured with connected discontinuous reception (C-DRX) on a first carrier, and the first time period is a non-active time of cell discontinuous transmission (DTX) configured by the network device on the first carrier.
